(19) United States
(12) Patent Application Publication
(10) Pub. No.: US 2018/0051605 A1
(43) Pub. Date: Feb. 22, 2018

(54) CONDUIT FOR MAINTAINING TEMPERATURE OF FLUID

(71) Applicant: Caterpillar Inc., Peoria, IL (US)

(72) Inventors: Brandyn A. Stack, Lafayette, IN (US); Rodney A. Lawrence, Frankfort, IN (US); Eric Ferguson, Cottage Grove, MN (US)

(73) Assignee: Caterpillar Inc., Peoria, IL (US)

(21) Appl. No.: 15/237,752

(22) Filed: Aug. 16, 2016

(51) Int. Cl. F01M 13/00; F16L 53/00; F02M 25/06

(52) U.S. Cl. CPC F01M 13/00; F16L 53/008; F01M 2013/0472; F01M 2013/0005; F02M 25/06

(57) ABSTRACT

A conduit for transferring fluid from one location to another. The conduit includes a tube having an outer surface and an insulation layer surrounding the tube. A heating layer is disposed between the insulation layer and the tube, such that the heating layer is wrapped around the outer surface of the tube. The conduit includes a reinforcement layer sandwiched between the insulation layer and the heating layer.

### TECHNICAL FIELD

The present disclosure generally relates to a conduit. More particularly, the present disclosure relates to a conduit for maintaining a temperature of a fluid flowing through the conduit.

### BACKGROUND

Prime mover engine applications, such as, transportation vehicles (including, automobiles, trains, aircraft, refrigeration trailers and the like), stationary equipment such as diesel engine driven electric generators etc., include conduits to provide a flow passage and convey fluids from one location to another.

Some of these prime mover engine systems may include a crankcase ventilation system that utilizes a plurality of conduits to receive blow-by gases from a crankcase of the engine. In cold weather conditions, where the temperature of ambient surroundings around the conduits is below freezing point of water and/or dew-point temperature of blow-by gases, blow-by gases present in the conduits may lose heat and may cause condensation of water vapors present in the blow-by gases. This condensation of water vapors may lead to formation of emulsion within the conduit. Furthermore, in some conditions the condensed water vapor may freeze into ice. Formation of emulsions and/or ice may disrupt the flow of the blow-by gases that may lead to increased crankcase pressure and may cause oil leakage from various engine components. Additionally, formation of emulsions and/or ice may cause damage to engine components and an after treatment module.

US 20120125913 discloses an apparatus for heating a pipe. An inner sheet covers the pipe such that an inner surface of the inner sheet faces the outer surface of the pipe. A heating wire is distributed on the outer surface of the inner sheet. Further, US 20120125913 discloses an insulation pad stacked on the outer surface of the inner sheet such that the insulation pad insulates the heat emitted from the heating wire.

### SUMMARY OF THE INVENTION

In an aspect of the present disclosure, a conduit is disclosed. The conduit includes a tube having an outer surface and an insulation layer surrounding the tube. A heating layer is disposed between the insulation layer and the tube, such that the heating layer is wrapped around the outer surface of the tube. Further, the conduit includes a reinforcement layer sandwiched between the insulation layer and the heating layer.

In another aspect of the present disclosure, a crankcase ventilation system for an internal combustion engine is disclosed. The crankcase ventilation system includes a crankcase and a conduit coupled to the crankcase and configured to receive blow-by gases from the crankcase. The conduit includes a tube having an outer surface, an insulation layer surrounding the tube, a heating layer disposed between the insulation layer and the tube such that the heating layer is wrapped around the outer surface of the tube and a reinforcement layer sandwiched between the insulation layer and the heating layer.

In yet another aspect of the present disclosure, a method of manufacturing a conduit is disclosed. The method includes providing a tube having an outer surface, wrapping a heating layer on the outer surface of the tube, covering the heating layer by a reinforcement layer and encapsulating the reinforcement layer by an insulation layer.

### BRIEF DESCRIPTION OF THE DRAWINGS

FIG. 1 is a diagrammatic illustration of an exemplary engine system in accordance with an embodiment of the present disclosure;

FIG. 2 is a diagrammatic illustration of the exemplary engine system in accordance with another embodiment of the present disclosure;

FIG. 3 illustrates a conduit used in the engine system of FIG. 1 and FIG. 2, in accordance with an embodiment of the present disclosure;

FIG. 4a illustrates a portion of the conduit wherein a heating layer is disposed on the outer surface of a tube;

FIG. 4b illustrates a portion of the conduit wherein a heating layer in the form of one or more strip heater is disposed on the outer surface of the tube, in accordance with an embodiment of the present disclosure;

FIG. 4c illustrates a portion of the conduit wherein the one or more strip heaters are coiled around the tube in different patterns;

FIG. 4d illustrates the one or more strip heaters being placed on the outer surface of a tube that includes a plurality of sharp bends;

FIG. 4e illustrates a portion of the conduit wherein a reinforcement layer encases the heating layer;

FIG. 4f illustrates a portion of the conduit wherein an insulation layer is provided over the reinforcement layer;

FIG. 4g illustrates a sock of insulation layer being disposed over the reinforcement layer in accordance with an embodiment of the present disclosure;

FIG. 4h illustrates a portion of the conduit wherein a cover layer is provided on the insulation layer;

FIG. 5 is a side view of the conduit, shown in FIG. 3, that illustrates the structural arrangement of the conduit;

FIG. 6 is a flowchart depicting a method of manufacturing a conduit in accordance with an embodiment of the present disclosure.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

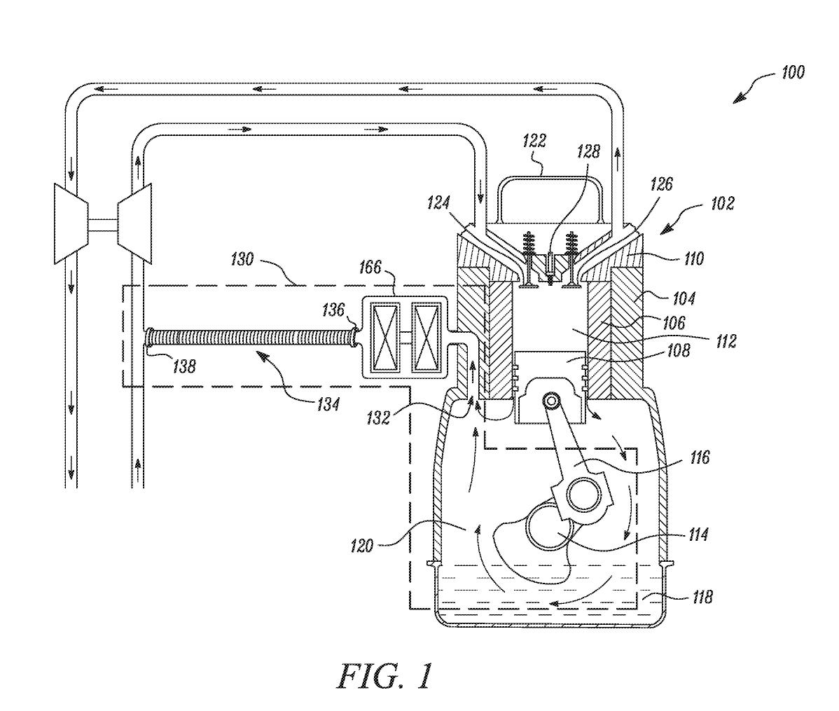

FIG. 1 illustrates an engine system 100. The engine system 100 includes an engine 102. The engine 102 may be configured to convert the chemical energy of the fuel into mechanical output. The engine 102 may be any engine running on solid, liquid or gaseous fuel, used for various purposes such as a power generation, a marine vessel, an automobile, a construction machine, any transportation vehicle and the like. In an embodiment, the engine 102 may be an internal combustion engine running on a hydrocarbon fuel.

The engine 102 may include an engine block 104 that at least partially defines one or more cylinders 106 (only one shown in FIG. 1), a piston 108 slidably disposed within each cylinder 106, and a cylinder head 110 that connects to the engine block 104 to cap off an end of cylinder 106. The cylinder 106, piston 108, and cylinder head 110 may together form a combustion chamber 112. The engine 102 may include any number of combustion chambers 112, and the combustion chambers 112 may be disposed in an “in-line” configuration, a “V” configuration, or in any other suitable configuration.

The engine 102 may also include a crankshaft 114 that is rotatably disposed within the engine block 104. A connecting rod 116 may connect each piston 108 to crankshaft 114 so that a sliding motion of the piston 108 between a top-dead-center position (farthest position of the piston 108 from the crankshaft 114) and a bottom-dead-center position (nearest position of the piston 108 from the crankshaft 114) within each respective cylinder 106 results in a rotation of the crankshaft 114. Similarly, a rotation of the crankshaft 114 may result in a sliding motion of piston 108 between the top-dead-center and bottom-dead-center positions.

An oil pan 118 may be connected to the engine block 104 to form a cavity known as a crankcase 120 located below the combustion chambers 112. Lubricant, for example engine oil, may be provided from the oil pan 118 to the engine surfaces to minimize metal-on-metal contact and thereby inhibit damage to the surfaces. Oil pan 118 may serve as a sump for collecting and supplying this lubricant.

Engine valves, for example exhaust valve 126 and intake valve 124 may be provided in valve openings (not shown), provided on the cylinder head 110. The exhaust valve 126 and intake valve 124 may be associated with the flow of fluids into and out of the combustion chamber 112, and be timed to move in relation to the movement of the piston 108. For example, as the crankshaft 114 rotates the piston 108 through the intake stroke, the intake valve 124 may open to allow air or an air and fuel mixture to be drawn or forced into the combustion chamber 112. During the compression and power strokes, both the intake valve 124 and the exhaust valve 126 may be closed to minimize leakage of gases from the combustion chamber 112. During the exhaust stroke, the exhaust valve 126 may open to allow by-products of combustion to be pushed from the combustion chamber 112. A valve cover 122 may be disposed on the cylinder head 110. The valve cover 122 may be configured to house the intake valve 124 and the exhaust valve 126.

Further, an ignition plug 128 may be disposed at least partially in the combustion chamber 112. The ignition plug 128 may be connected to the cylinder head 110 by a threaded connection or other methods known in the art. The ignition plug 128 may be a typical J-gap spark plug, a spark plug with a pre-chamber, rail plug, extended electrode, or laser plug or any other type of spark plug known in the art. It may be contemplated that in various other engines such as diesel engines, etc. the ignition plug 128 may not be present.

The engine system 100 further includes a crankcase ventilation system 130 for the engine 102 as shown in FIG. 1. The crankcase ventilation system 130 is configured to allow one way passage for blow-by gases (the air fuel mixture and/or the exhaust gases produced within the combustion chamber 112) that leak past the piston 108 to escape in a controlled manner from the crankcase 120 of the engine 102. The crankcase ventilation system 130 includes the crankcase 120. The crankcase 120 forms the housing for the crankshaft 114. The crankcase 120 defines a cavity in the engine 102 and is located below the cylinder(s) 106.

The crankcase ventilation system 130 further includes an outlet 132 provided within the engine 102. The outlet 132 is in fluid communication with the crankcase 120 and is configured to vent the blow-by gases from the crankcase 120. In the embodiment illustrated, the outlet 132 is provided within the engine block 104. In an alternate embodiment, the outlet 132 may be an opening provided in the crankcase 120.

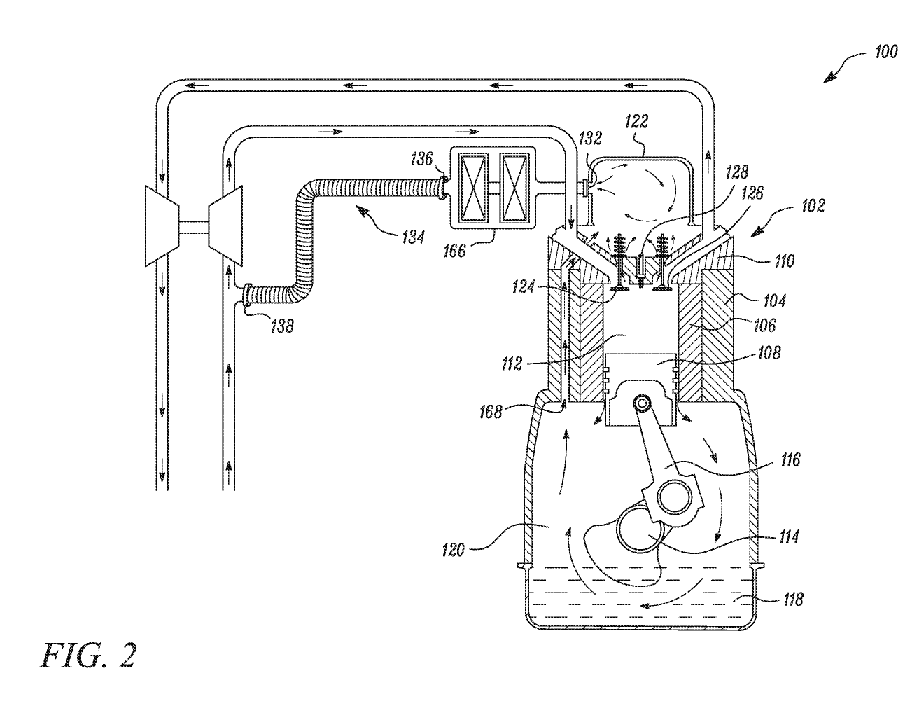

In an alternate embodiment, the outlet 132 may be in various cavities defined within the engine 102. The outlet 132 may be configured to vent out the blow-by gases that may have accumulated in the plurality of cavities defined within the engine 102. For example, the outlet 132 may be in the valve cover 122 as shown in FIG. 2. The outlet 132, as shown in FIG. 2, may be configured to vent the blow-by gases that crept past the intake valve 124 and the exhaust valve 126 and got accumulated within the valve cover 122. Further, as illustrated in FIG. 2, the valve cover 122 may be coupled to the crankcase 120 via a connecting passage 168. The connecting passage 168 may be configured to fluidly couple the valve cover 122 and the crankcase 120 thereby venting out the blow-by gases that may have accumulated in the crankcase 120.

In various other embodiments, the air fuel mixture and/or the exhaust gases produced within the combustion chamber 112 may leak past the piston 108 and accumulate within a cavity defined within the engine 102. For example, the blow-by gases may escape the combustion chamber 112 and accumulate in the cam gallery (not shown). Thus, it may be contemplated that the blow-by gases may escape the combustion chamber 112 and accumulate within various other cavities defined by the engine such as front housing, rear housing, etc. Accordingly, plurality of outlets 132 may be provided within the engine 102 such that they are in fluid communication with the cavities defined within the engine 102 wherein the outlets 132 are configured to vent the blow-by gases accumulated within the cavities. It may be contemplated that the cavities defined within the engine 102 may be formed within the cylinder block 104, front housing or rear housing. Further, it may be contemplated that these cavities may be in fluid communication the crankcase 120 via other connecting passages. In an embodiment, the cavities defined within the cylinder block 104, front housing and rear housing may form a fraction of the crankcase 120 volume.

The crankcase ventilation system 130 includes a conduit 134. The conduit 134 is configured to receive the blow-by gases from the crankcase 120 via the outlet 132. The conduit 134 includes a first conduit end 136, and a second conduit end 138. The first conduit end 136 may be coupled to the crankcase ventilation filtration device 166 that may be disposed between the outlet 132 and the first conduit end 136. In an alternate embodiment, the first conduit end 136 may be directly coupled to the outlet 132. The second conduit end 138 may be coupled to an air intake system or vented to the atmosphere. The first conduit end 136 and the second conduit end 138 may be coupled to the crankcase ventilation filtration device 166 and the air intake system respectively using a connector, coupler, or any other means known in the art.

The term “conduit” may refer to any general tubular, elongated member or device and that could be flexible, semi-flexible and rigid devices commonly referred to as “hoses,” “tubes,” “pipes” and the like. The conduit 134 may have different cross-section shapes, and may have for example, round, oval, polygonal or any other cross sectional shape.

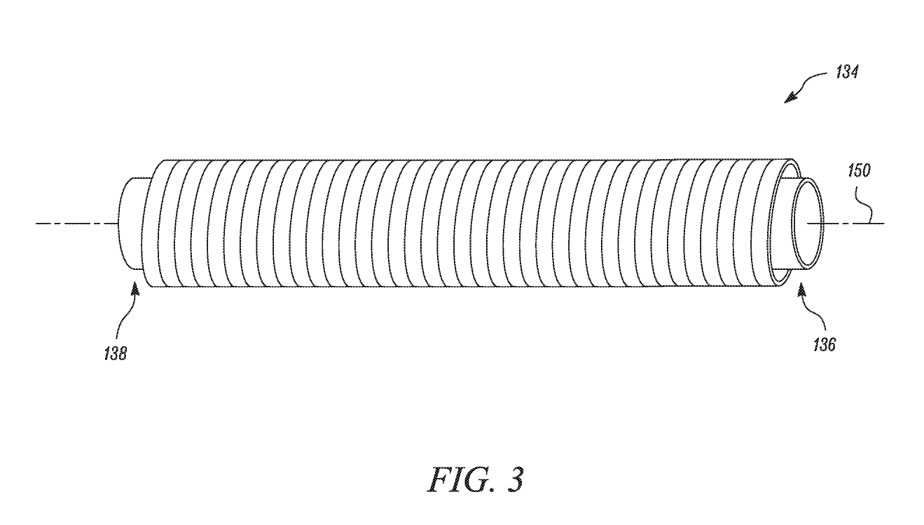

For the purpose of better understanding, FIG. 3-FIG. 5 illustrate the conduit 134 as tubular device axially extending along a central longitudinal axis 150, up to a predetermined length between the first conduit end 136 and the second conduit end 138. However, it may be contemplated that the conduit 134 may be of any shape such as a V-shaped conduit, a L-shaped conduit, J-shaped conduit, T shaped conduit with 2 or more connections, bent conduit or any other complex shaped conduit.

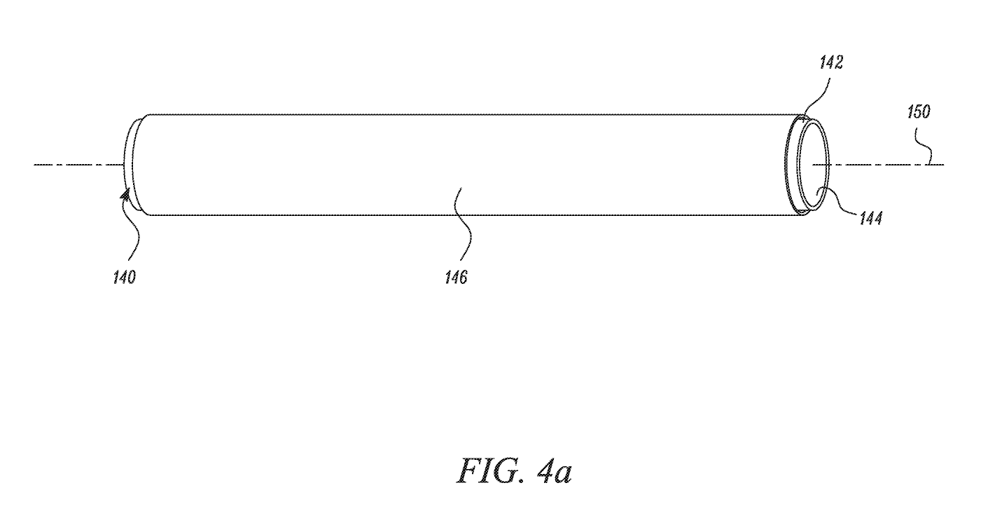

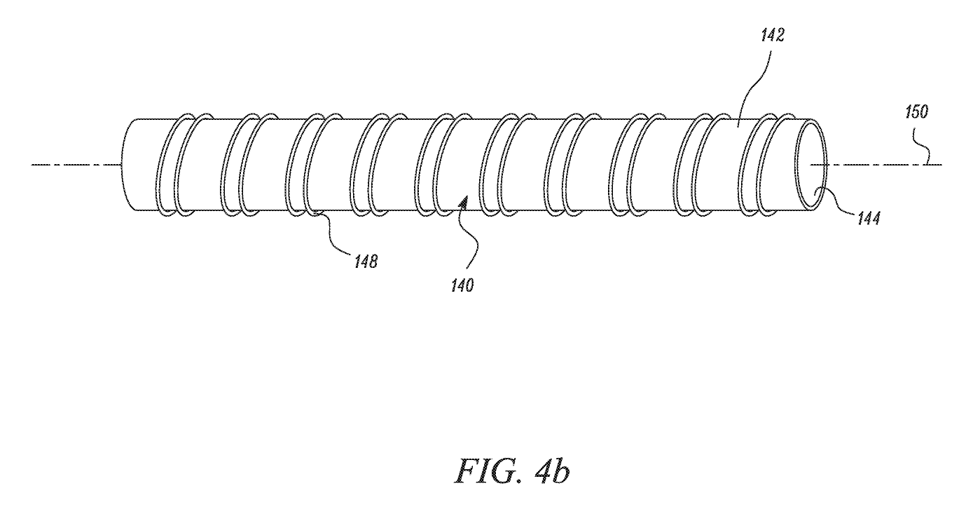

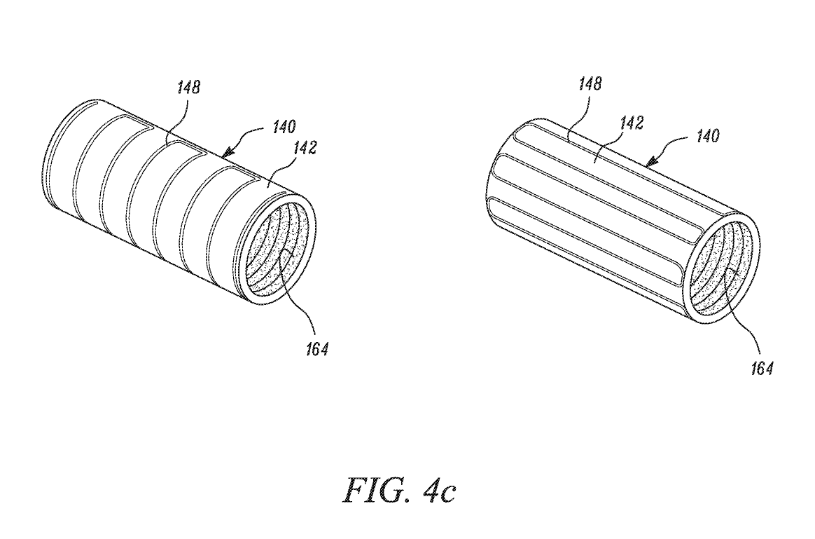

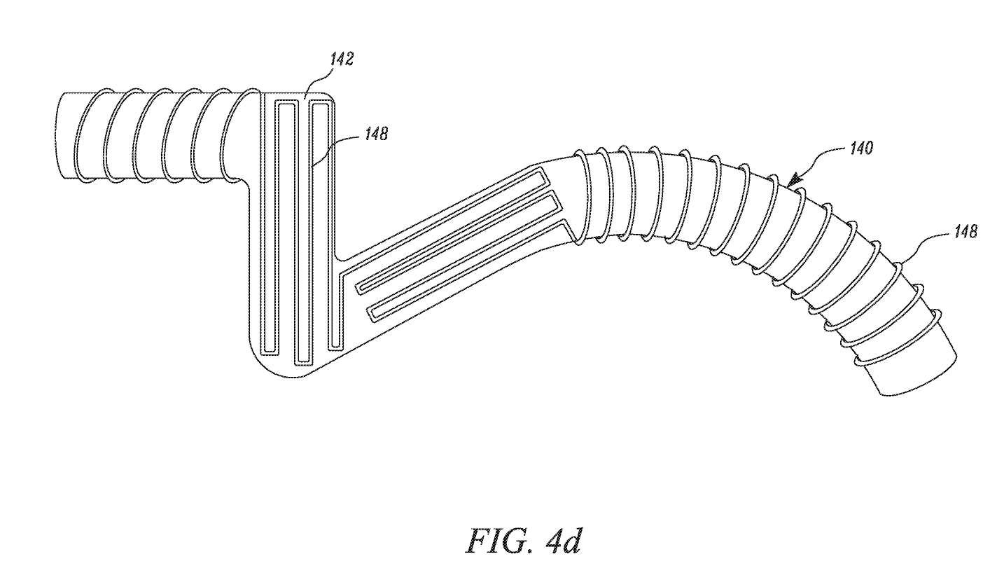

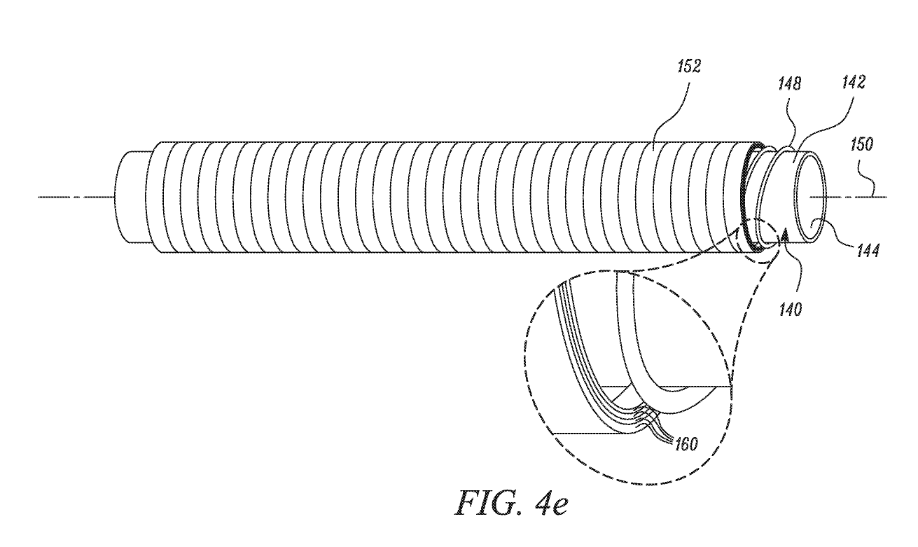

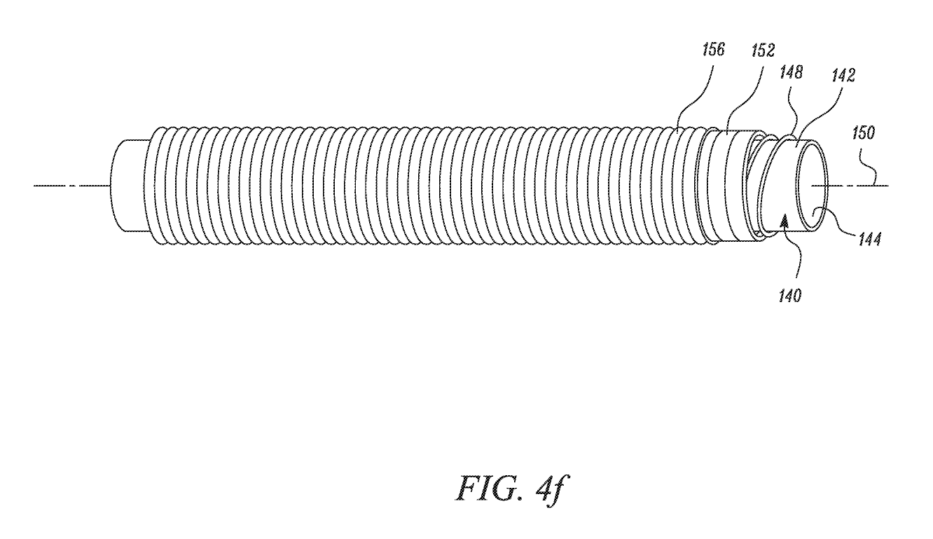

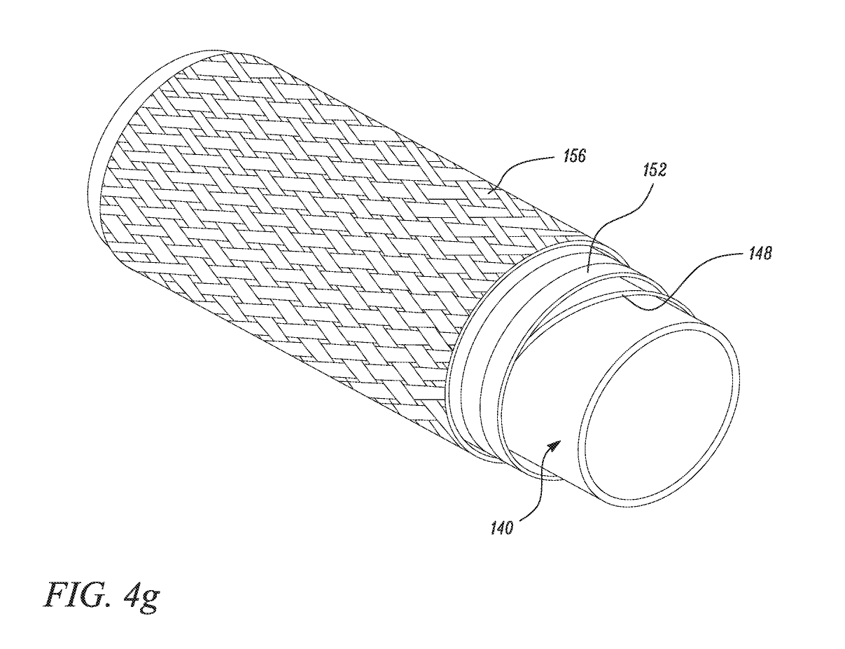

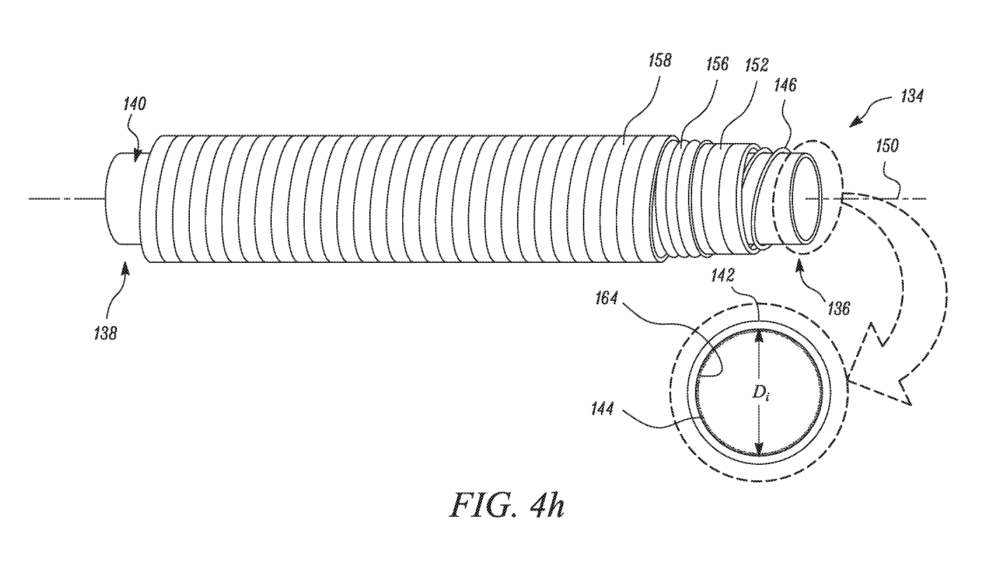

As depicted in FIG. 4a, the conduit 134 includes a tube 140. The tube 140 may be of a single-layer construction or a multi-layer construction. The tube 140 is used to convey liquids and gases from one location to another. The tube 140 has a circumferential outer surface 142 and a circumferential inner surface 144 which defines the inner diameter, referenced at Di (shown in FIG. 4h), of conduit 134. In the preferred embodiment, the tube 140 may be moulded, extruded or otherwise formed of sheet stock silicone. In various other embodiments, the tube 140 may be provided as a moulded, extruded or otherwise formed of a polymeric material such as a polyamide, aramid, ethylene vinyl alcohol, polyoxymethylene, AEM, polyolefin, silicone, fluoropolymer, FKM, FVMQ, polyvinyl chloride, polyurethane, thermoplastic elastomer, EPDM, NBR, HNBR, acrylic or a copolymer or blend thereof. The tube 140 may be formed of one or more layers of the above-mentioned materials, wherein each of the layer may be independently formed.

The conduit 134 further includes a heating layer 146 provided on the outer surface 142 of the tube 140. The heating layer 146 is configured to heat the outer surface 142 of the tube 140 so as to heat the fluids within the conduit 134. This heating of the outer surface 142 of the tube 140 helps in increasing the temperature of the fluid present within the tube 140.

In the embodiment illustrated, as shown in FIG. 4b, the heating layer 146 may be a strip heater 148, provided on the outer surface 142 of the tube 140, such that it surrounds the tube 140. In an alternate embodiment, the heating layer 146 may include a plurality of strip heaters 148 surrounding the outer surface 142 of the tube 140. The strip heaters 148 are configured to heat the outer surface 142 of the tube 140. The strip heaters 148 may be wires made up of a stainless or carbon steel alloy, or another metal such as copper or carbon fibers or metal alloy such as NiCr (Nickel Chromium wire). The strip heaters 148 may be sheathed within a plastic or other polymeric coating such as PTFE or silicone to provide corrosion resistance and electrical isolation. Further, as shown, the strip heaters 148 may be spiral, i.e., helically, wound around the outer surface 142 of the tube 140. The strip heaters 148 may be wound at a uniform pitch and pitch angle to ensure a uniform spacing between the turns for more even heat distribution. The strip heaters 148 may have adhesive on its outer surface so that the strip heater 148 adheres to the outer surface 142 of the tube 140. The adhesive ensures that the strip heaters 148 adhere to their location and do not slide on the outer surface 142. It will be appreciated that by varying the number of strip heaters 148, or by changing the pitch or pitch angle, and/or the wire gauge or the number of wires in a braid or type, the amount of heat input into the tube 140 may be adjusted to provide a specified watt per meter rating and/or thaw time.

In an alternate embodiment, the strip heater 148 may be disposed over the outer surface 142 of the tube 140 in some unique predefined patterns, as shown in FIG. 4c. For example, the strip heater 148 may be coiled back and forth along the circumference of the tube 140 as shown in (left illustration of) FIG. 4c. In another embodiment, the strip heaters 148 may be coiled back and forth along the length of the tube 140 as shown in (right illustration of) FIG. 4c. FIG. 4d illustrates the tube 140 having sharp bends and changing concavities. In such types of tubes 140, the strip heater 148 are coiled around the tube 140 in various patterns. For example, as shown in FIG. 4d, the strip heaters 148 are coiled spirally along the outer surface of the tube 140 in the straight sections of the tube 140. However, the tube 140 has sudden bends or sudden change in concavities and spirally wrapping the one or more strip heaters 148 may lead to snapping of the strip heaters 148 which may prevent the heating layer 146 from performing its function. Accordingly, in such sections of the conduit 134 the one or more strip heater 148 are disposed on the outer surface 142 of the tube 140 such that the strip heaters 148 take unique routes (such as back and forth coiling as shown in FIG. 4d) around the bent cross section of the tube 140 or follow a more neutral axis for mandrel tool removal so as to reduce the stress developed within the strip heater 148 thereby preventing it from snapping.

Referring to FIG. 4e, the conduit 134 further includes a reinforcement layer 152 provided over the heating layer 146 such that the heating layer 146 is sheathed within the reinforcement layer 152. The reinforcement layer 152 is configured to add strength and reinforce the conduit 134 to withstand the pressure or vacuum developed within the tube 140 and the stress developed in the tube 140. The reinforcement layer 152 is further configured to add creep strength and structural strength to withstand the forces that may tend to damage the conduit 134. The reinforcement layer 152 is also configured to support its own weight thereby preventing itself from sagging. The reinforcement layer 152 may also be configured to reduce and combat the vibrations that may be encountered by the conduit 134 during engine 102 operation. Furthermore, the reinforcement layer 152 may further be configured to protect the heating layer 146 from damage by an external impact, object, etc. In the embodiment illustrated, the reinforcement layer 152 is spirally wrapped over the heating layer 146. The reinforcement layer 152 may be equipped with an adhesive on its surface so as to secure the reinforcement layer 152 over the heating layer 146. In various other embodiments, the reinforcement layer 152 may be spray-applied, dip coated, cross-head or co-extruded, or otherwise conventionally extruded, longitudinally, i.e., “cigarette,” wrapped, or braided over the heating layer 146. The reinforcement layer 152 may be composed of polyester, nylon, meta-aramid, aramids, fiberglass Nomex®, Kevlar®, polyamides with or without impregnated with silicone or other rubber materials, (such as, but not limited to NBR, HNBR, EPDM, VMQ, FVMQ, FKM, etc.

The reinforcement layer 152 may be wrapped around the heating layer 146 such that a plurality of sub-layers of reinforcement material 160 are formed on the heating layer 146. These one or more sub-layers of reinforcement material 160 coaxially surrounding the heating layer 146 together constitute the reinforcement layer 152.

Referring to FIG. 4f, the conduit 134 further includes an insulation layer 156 provided over the reinforcement layer 152. The insulation layer 156 encases the reinforcement layer 152 i.e. covers the reinforcement layer 152 cover in a close-fitting surrounding. Thus, the insulation layer 156 surrounds tube 140 such that the heating layer 146 is disposed between the tube 140 and the insulation layer 156 and the reinforcement layer 152 lies between the heating layer 146 and the insulation layer 156. The insulation layer 156 is configured to thermally insulate the conduit 134 from the ambient surrounding. The insulation layer 156 reduces heat loss in a radially outward direction. This ensures effective utilization of the heat generated by the heating layer 146 to heat the blow-by gases and fluids present within the tube 140.

In the embodiment illustrated, the insulation layer 156 is spirally, wrapped over the reinforcement layer 152. In an embodiment, the insulation layer 156 may be secured to the reinforcement layer 152 via an adhesive disposed between the two layers. In an alternate embodiment, the insulation layer 156 may firstly be placed over the reinforcement layer 152 and then be cured. In various other embodiments, the insulation layer 156 may be spray-applied, dip coated, cross-head or co-extruded, or otherwise conventionally extruded, longitudinally, i.e., “cigarette,” wrapped, or braided over the reinforcement layer 152. In the embodiment illustrated, the insulation layer 156 is a woven fiberglass insulation material helically wrapped over the reinforcement layer 152. In an alternate embodiment, the insulation layer 156 may be a layer of knitted fiberglass insulation material surrounding the reinforcement layer 152. The insulation layer 156 made up of knitted fiberglass insulation material may have air gaps between the fiberglass threads in the knitted construction. These air gaps (or air pockets) present in the insulation layer 156 improve the insulating capacity of the insulation layer 156. In various other embodiments the insulation layer 156 may be made up of loose fiberglass, fiberglass batting, mineral wool, mineral fiber, and basalt insulation materials.

In various other embodiments, the insulation layer 156 may be provided, for example, as a braided material spiral, i.e., helically, or otherwise wound, and/or wrapped or otherwise formed to surround the reinforcement layer 152. In an embodiment, the insulation layer 156 may be a sock of insulation material disposed over the reinforcement layer 152, as shown in FIG. 4g. Further, in various other embodiments, the insulation layer 156 may be formed of one or more filaments, which may be monofilaments, continuous multifilament, i.e., yarn, stranded, cord, roving, thread, braid, tape, or ply, or short “staple” strands, of one or more fiber materials.

Cord, as used herein, is a twisted or formed structure composed of one or more single or plied filaments, strands, or yarns of inorganic materials, such as glass or ceramic. A filament is a continuous fiber of indefinite or extremely long length. A filament yarn is a yarn composed of continuous filaments assembled with or without twist. A yarn is a generic term for a continuous strand of textile fibers, filaments, or material, in a form suitable for knitting, weaving or otherwise intertwining to form a textile fabric. Tire cord fabric or unidirectional cord fabric, as used herein is a fabric in which multiple warp cords are held together in parallel, unidirectional fashion by weaving with small fill yarns.

The cords are made of one or more yarns of continuous glass or ceramic filaments which are twisted, plied, and/or cabled together to form cords. The glass composition used in the glass cord may be E-glass, S-glass, basalt, or any other suitable glass composition. The glass filaments are generally coated with a sizing shortly after spinning or drawing.

Referring to FIG. 4h, the conduit 134 further includes a cover layer 158 provided over the insulation layer 156. The cover layer 158 is configured to protect the inner layers (tube 140, heating layer 146, reinforcement layer 152 and insulation layer 156) from damage and cuts. Further, the cover layer 158 seals the inner layers together and adds structural compactness to the conduit 134. The cover layer 158 prevents water being absorbed by the insulation layer 156 thereby avoiding expansion of the insulation layer 156. The cover layer 158 thus prevents the insulation layer 156 and the other inner layers from expanding and preventing the conduit 134 from ripping apart. The cover layer 158 may be wound, wrapped, or braided around the insulation layer 156. In various other embodiments, the cover layer 158 may be spray-applied, dip coated, cross-head or co-extruded, or otherwise conventionally extruded over the insulation layer 156. The cover layer 158 may be formed, independently, of a polymeric material such as aramid, meta-aramid, nylon, fiberglass, polyamide, polyester, polyacetal, ethylene vinyl alcohol, polyoxymethylene, polyolefin, silicone, fluoropolymer, polyvinyl chloride, polyurethanes, thermoplastic elastomer, EPDM, natural or synthetic rubber, or a copolymer or and blend thereof.

In an embodiment, as shown in FIG. 4h and FIG. 4c, the conduit 134 may further include an anti-corrosive coating 164 provided on the inner surface 144 of the tube 140. The anti-corrosive coating 164 comprises of an inert compound coated or painted on the inner surface 144 of the tube 140 which prevents corrosion on the inner surface 144 of the tube 140. In the embodiment illustrated, the anti-corrosive coating 164 is an FKM lining (fluorocarbon coating). In an alternate embodiment, the anti-corrosive coating 164 is an organic amine, which acts as a corrosion inhibitor by adsorbing on the inner surface 144 of the tube 140, thereby restricting the access of potentially corrosive species (e.g. H₂S, SO₂, SO₃, sulfuric acid, dissolved oxygen, carbonic acid, chloride/sulfate anions, etc.). In an embodiment, the anti-corrosive coating 164 may be two or more organic amines. In an embodiment, the anti-corrosive coating 164 is a polyamine. In various other embodiments, the anti-corrosive coating 164 may be an inert compound known in the art.

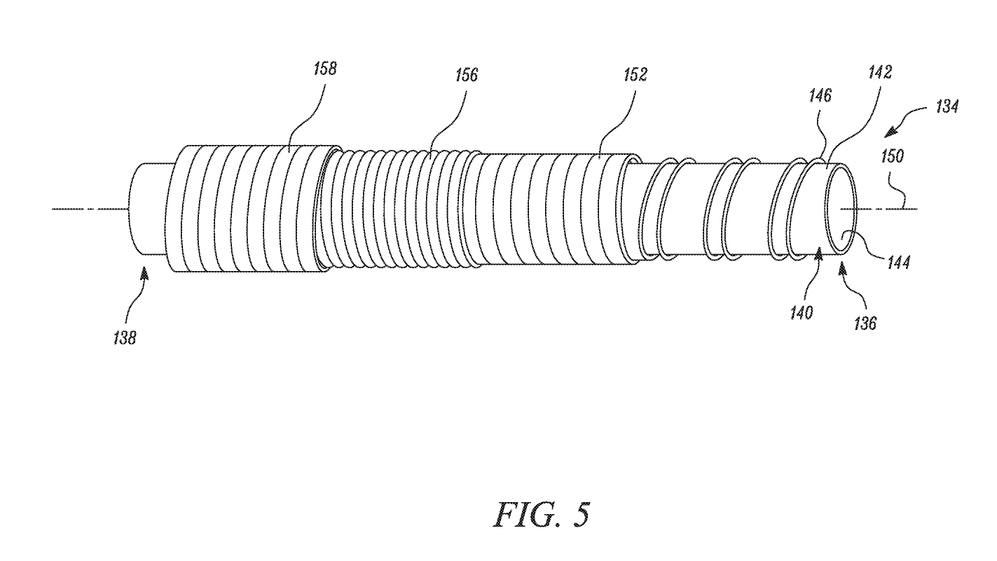

FIG. 5 shows the overall structural composition of the conduit 134. The conduit 134 comprises the tube 140, the heating layer 146, the reinforcement layer 152, the insulation layer 156 and the cover layer 158. The heating layer 146 is provided over the outer surface 142 of the tube 140 such that the heating layer 146 lies between the tube 140 and the insulation layer 156. Further, the reinforcement layer 152 is provided over the heating layer 146 such that it is sandwiched between the insulation layer 156 and the heating layer 146. The resultant combination of these layers provides the conduit 134 with the ability to heat the conduit 134 and minimize the fluids present within the conduit from freezing. Furthermore, the layers present within the conduit 134 reduce the opportunity for water vapour present within the conduit 134 to condense.

In the embodiment illustrated, as shown in FIG. 1, the crankcase ventilation system 130 may include the crankcase ventilation filtration device 166. The crankcase ventilation filtration device 166 receives the blow-by gases from the conduit 134. The crankcase ventilation filtration device 166 may be configured to reduce the particulate matter from the blow-by gases. The crankcase ventilation filtration device 166 may further be configured to separate the oil that may have been carried by the blow-by gases from the crankcase 120. The blow-by gases with reduced amount of particulate matter and oil may be recirculated to the engine 102, as shown in FIG. 1. In an alternate embodiment, the crankcase ventilation filtration device 166 may reduce the quantity of harmful pollutants. Thus, in such cases the blow-by gases emanating from the crankcase ventilation filtration device 166 may be released straight into the atmosphere.

### INDUSTRIAL APPLICABILITY

In cold weather conditions, where the temperature of ambient surroundings around a conduit is below dew-point temperature of blow-by gases, fluids present in the conduits may lose heat and may cause condensation of water vapors present within the fluids. This condensation of water vapors may lead to formation of emulsions within the conduit. Furthermore, in some conditions the condensed water vapor may freeze into ice. Formation of emulsions and/or ice may disrupt the flow of the fluids.

In an aspect of the present disclosure, a conduit 134 is disclosed, as shown in FIG. 3-FIG. 5. The conduit 134 comprises the tube 140, the heating layer 146, the reinforcement layer 152, the insulation layer 156, the cover layer 158 and the anti-corrosive coating 164. The tube 140 is the innermost elongated tubular structure which provides a passageway for transferring fluids from one location to another.

The heating layer 146 is disposed between the insulation layer 156 and the tube 140 such that the heating layer 146 lies on the outer surface 142 of the tube 140. The heating layer 146 is configured to heat the outer surface 142. The reinforcement layer 152 is sandwiched between the heating layer 146 and the insulation layer 156. The reinforcement layer 152 adds strength and resistance to withstand the forces that may tend to damage the conduit 134.

The heating layer 146 heats the conduit 134 such that the outer surface 142 of the tube 140. The heat is then transferred from the outer surface 142 to the fluids present within the conduit 134. During cold weather conditions heat is lost to the ambient surroundings by the fluids present within the conduit 134. The presence of the heating layer 146 at least partly compensates for the heat lost to the ambient surrounding thereby minimizing the formation of sludge and/or ice within the conduit 134. Thus, in cold weather environments the heating layer 146 can provide sufficient heat to the outer surface 142 of the tube 140 and minimize precipitation of water and/or forming of ice within the conduit 134.

Further, in extreme cold weather conditions the heat transferred to the fluids within the tube 140, by the heating layer 146 may not be sufficient to avoid formation of emulsions and or ice within the conduit 134. This may lead to machine downtime, loss of productivity and engine damage. However, the presence of the insulation layer 156 over the tube 140 obviates the problem. The insulation layer 156 thermally insulates the conduit 134 from the environment and creates a heat blanket (via the heating layer 146) around the tube 140. The insulation layer 156 reduces heat loss in a radially outward direction thereby reducing the amount of heat dissipated by the fluid within the conduit 134 to the atmosphere. Further, the insulation layer 156 ensures effective utilization of the heat generated by the heating layer 146 to heat the blow-by gases and fluids present within the tube 140. Furthermore, since the insulation layer 156 helps in creating a heat blanket around the outer surface 142 of the tube 140 it obviates the need for the heating layer 146 to continuously transfer heat to the tube 140. Thus, the heating source of the heating layer 146 may be turned off periodically to conserve power. The layers of the conduit 134 provide an overall effect that at least partly helps in maintaining the temperature of the fluids within the conduit 134 in a predetermined range (the range of temperature wherein the formation of sludge and/or ice is reduced).

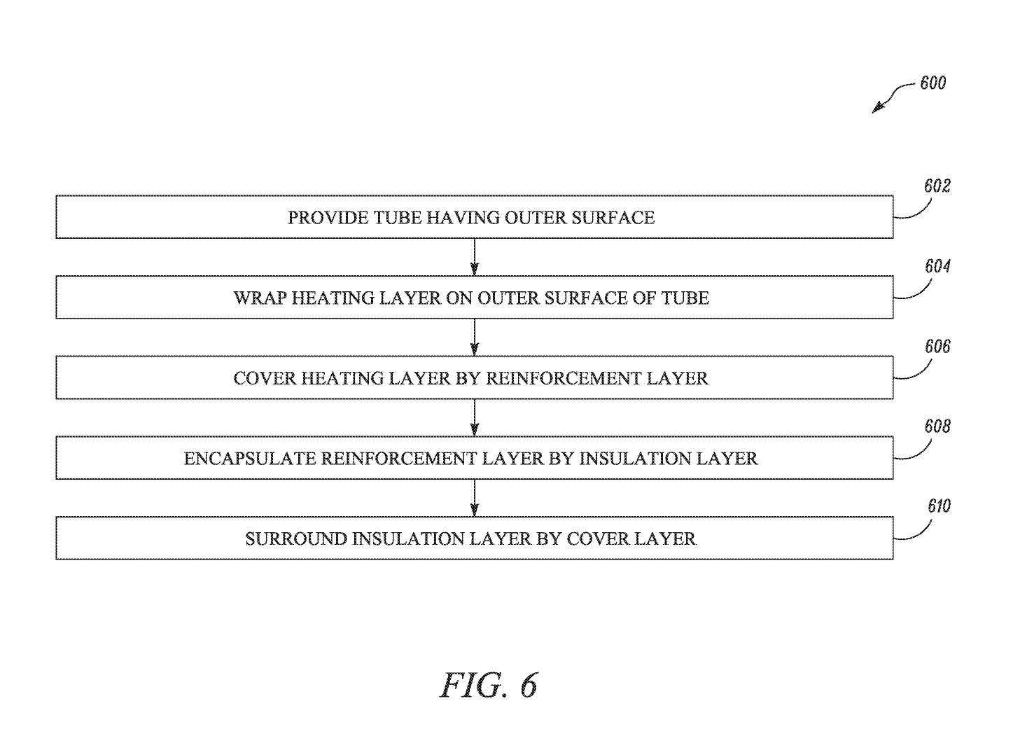

Further, the present disclosure, as shown in FIG. 6, discloses a method 600 of manufacturing the conduit 134. The method 600 includes providing the tube 140 (Step 602). The tube 140 has the outer surface 142 over which the heating layer 146 is wrapped (Step 604). The heating layer 146 may include strip heaters 148 (which may be heating wires) helically coiled/wrapped around the outer surface of the tube 140. The heating layer 146 is covered by the reinforcement layer 152 (Step 606). The reinforcement layer 152 is spirally wrapped around the heating layer 146. The insulation layer 156 is disposed over the reinforcement layer 152 such that it encapsulates the reinforcement layer 152 (Step 608). The insulation layer 156 is also spirally wrapped around the reinforcement layer 152. The method 600 may further include providing a cover layer 158 surrounding the insulation layer 156 (Step 610). The cover layer 158 prevents water being absorbed by the insulation layer 156 thereby avoiding expansion of the insulation layer 156. The method 600 may further include providing an anti-corrosive coating 164 on an inner surface 144 of the tube 140. Furthermore, the method 600 may further include providing a cover layer 158 around the insulation layer 156.

Since the method of manufacturing the conduit 134 includes the layers being spirally or helically wrapped around the tube 140, this method may be utilized for making complex shaped conduits 134 (as shown in FIG. 4d) which have tubes that include sharp bends and plurality of concavities. The layers can be easily formed around the tube 140 as they only need to be wrapped around the cross section of the tube 140.

It may be contemplated that the conduit 134 may not have the heating layer 146 and the insulation layer 152 over the entire outer surface 142 of the tube 140. For example, the first conduit end 136 and the second conduit end 138 may not have the heating layer 146 and the insulation layer 152. The absence of the heating layer 146 and the insulation layer 152 may help in easy installation of the hose clamp. Further, in complex shaped conduits 134 the heating layer 146 and the insulation layer 156 may only be provided in the straight sections of the conduit 134. Further, in other complex shaped conduits 134 such as a T-shaped conduit, the heating layer 146 may be disposed only on the mid-section of the T leg. In various other embodiments, the conduit 134 may be such that the heating layer 146 and the insulation layer 156 may be disposed partly over the outer surface 142 of the tube 140.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A conduit comprising:
a tube having an outer surface;
an insulation layer surrounding the tube;
a heating layer disposed between the insulation layer and the tube, wherein the heating layer is wrapped around the outer surface of the tube; and
a reinforcement layer sandwiched between the insulation layer and the heating layer.

2. The conduit of claim 1, wherein the heating layer corresponds to one or more strip heaters.

3. The conduit of claim 2, wherein the one or more strip heaters are helically wrapped around the outer surface of the tube.

4. The conduit of claim 1, wherein the insulation layer is a woven fiberglass insulation material.

5. The conduit of claim 1, further comprising an anti-corrosive coating provided on an inner surface of the tube.

6. The conduit of claim 5, wherein the anti-corrosive coating is FKM coating.

7. The conduit of claim 1, wherein the reinforcement layer includes a one or more sub-layers of a reinforcement material.

8. The conduit of claim 1, further comprising a cover layer around the insulation layer.

9. The conduit of claim 1, wherein the insulation layer is spirally wrapped around the heating layer.

10. A crankcase ventilation system for an internal combustion engine, the crankcase ventilation system comprising:
a crankcase; and
a conduit coupled to the crankcase and configured to receive blow-by gases from the crankcase, the conduit comprising:
a tube having an outer surface;
an insulation layer surrounding the tube;
a heating layer disposed between the insulation layer and the tube, wherein the heating layer is wrapped around the outer surface of the tube; and
a reinforcement layer sandwiched between the insulation layer and the heating layer.

11. The crankcase ventilation system of claim 10, wherein the heating layer of the conduit includes one or more strip heaters.

12. The crankcase ventilation system of claim 11, wherein the one or more strip heaters are helically wrapped around the outer surface of the tube.

13. The crankcase ventilation system of claim 10, further comprising an anti-corrosive coating provided on an inner surface of the tube.

14. The crankcase ventilation system of claim 13, wherein the anti-corrosive coating is FKM coating.

15. The crankcase ventilation system of claim 10, wherein the reinforcement layer includes a plurality of sub-layers of a reinforcement material.

16. A method of manufacturing a conduit, the method comprising:
providing a tube having an outer surface;
wrapping a heating layer on the outer surface of the tube;
covering the heating layer by a reinforcement layer; and
encapsulating the reinforcement layer by an insulation layer.

17. The method of claim 16, wherein wrapping the heating layer on the outer surface of the tube includes helically winding a strip heater around the outer surface of the tube.

18. The method of claim 16, wherein covering the heating layer by the reinforcement layer includes spirally wrapping the reinforcement layer around the heating layer.

19. The method of claim 16, further comprising providing an anti-corrosive coating on an inner surface of the tube.

20. The method of claim 16, further comprising providing a cover layer around the insulation layer.
